(19) United States
(12) Patent Application Publication
(10) Pub. No.: US 2024/0422845 A1
(43) Pub. Date: Dec. 19, 2024

(54) SYSTEM AND METHOD FOR BEACON FRAME GENERATION WITH AND WITHOUT MULTIPLE BASIC SERVICE SET IDENTIFIER (MBSSID) SUPPORT

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/745,816

(22) Filed: Jun. 17, 2024

Related U.S. Application Data
(60) Provisional application No. 63/508,344, filed on Jun. 15, 2023.
(60) Provisional application No. 63/520,051, filed on Aug. 16, 2023.
(60) Provisional application No. 63/520,131, filed on Aug. 17, 2023.

(51) Int. Cl. H04W 76/15; H04W 76/11

(52) U.S. Cl. CPC H04W 76/15; H04W 76/11

(57) ABSTRACT

Embodiments of a method and apparatus for communications are disclosed. In an embodiment, a communications device includes a controller configured to generate a beacon frame based on Multiple Basic Service Set Identifier (MBSSID) support information and a wireless transceiver configured to wirelessly transmit the beacon frame to a second communications device.

### CROSS-REFERENCE TO RELATED APPLICATIONS

This application is entitled to the benefit of U.S. Provisional Patent Application Ser. No. 63/508,344, filed on Jun. 15, 2023, U.S. Provisional Patent Application Ser. No. 63/520,051, filed on Aug. 16, 2023, and U.S. Provisional Patent Application Ser. No. 63/520,131, filed on Aug. 17, 2023, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey communications information, for example, beacon information within the wireless communications system.

### SUMMARY

Embodiments of a method and apparatus for communications are disclosed. In an embodiment, a communications device includes a controller configured to generate a beacon frame based on Multiple Basic Service Set Identifier (MBSSID) support information and a wireless transceiver configured to wirelessly transmit the beacon frame to a second communications device. Other embodiments are also disclosed.

In an embodiment, the beacon frame does not carry at least some access point (AP)'s capability and BSS operation information.

In an embodiment, the communications device includes a wireless access point (AP) of a first wireless multi-link device (MLD), and the second communications device includes a wireless non-AP station (STA) of a second wireless MLD.

In an embodiment, the controller is further configured to generate the beacon frame based on the MBSSID support information and non-Ultra High Reliability (UHR) Station (STA) association allowance information.

In an embodiment, the controller is further configured to generate the beacon frame that includes capability and BSS operation information other than UHR capability information and at least one UHR BSS operating parameter, and an indication whether the communications device supports UHR.

In an embodiment, the controller is further configured to generate an indication whether a critical change of UHR BSS operating parameters occurs and a BSS change count related to the critical change of the UHR BSS operating parameters.

In an embodiment, the controller is further configured to carry the critical update in beacon frames that include at least one delivery traffic indication map (DTIM) beacon frame.

In an embodiment, the controller is further configured to generate the beacon frame that includes basic information when MBSSID is not supported by the wireless AP and when non-UHR STA association is not allowed by the wireless AP, and the basic information includes an SSID element, a supported Rates and BSS Membership Selectors element, a traffic indication map (TIM) element, a security element, a transmit power control element, and critical update indication information and a BSS Parameters Change Count (BPCC).

In an embodiment, the controller is further configured to increase the BPCC and to distribute critical update information into beacon frames that include at least one delivery traffic indication map (DTIM) beacon frame, and a critical update flag field in the beacon frames is set to a specific value.

In an embodiment, the controller is further configured to generate an indication whether a critical change of UHR BSS operating parameters occurs and a BSS change count related to the critical change of UHR BSS operating parameters.

In an embodiment, the controller is further configured to generate the beacon frame that includes BSS management information without UHR information and at least one BSS operating parameter, and UHR support indication information when MBSSID is not supported by the wireless AP, and the BSS management information does not include UHR capability information and UHR BSS operating information.

In an embodiment, the controller is further configured to generate the beacon frame that includes basic information when MBSSID is supported by a wireless transmitted BSSID AP of a multiple BSSID set and when non-UHR STA association is not allowed for any AP within the multiple BSSID set, and the basic information includes an SSID element, a supported Rates and BSS Membership Selectors element, a traffic indication map (TIM) element, a security element, a transmit power control element, and critical update indication information and a BSS Parameters Change Count (BPCC).

In an embodiment, the controller is further configured to increase the BPCC and to distribute critical update information into beacon frames that include at least one delivery traffic indication map (DTIM) beacon frame, and a critical update flag field in the beacon frames is set to a specific value.

In an embodiment, the controller is further configured to generate the beacon frame that includes BSS management information and UHR support indication information when MBSSID is supported by a wireless transmitted BSSID AP of a multiple BSSID set and at least one AP of the multiple BSSID set allows non-UHR STA's association, and the BSS management information does not include UHR capability information and UHR BSS operating information.

In an embodiment, the controller is further configured to generate an indication whether a critical change of UHR BSS operating parameters occurs and a BSS change count related to the critical change of the UHR BSS operating parameters, and beacon frames that include at least one delivery traffic indication map (DTIM) beacon frame.

In an embodiment, the beacon frame includes a BSS Parameters Change Count (BPCC) of a wireless access point (AP), and when a multi-link device (MLD) associated with the wireless AP has a new critical update, the BPCC is increased and the increased BPCC is carried in each link of the MLD.

In an embodiment, the controller is further configured to generate a beacon extension frame based on the MBSSID support information, the beacon extension frame includes multi-link traffic indication information that is not carried in the beacon frame, and the wireless transceiver is further configured to transmit the beacon extension frame to the second communications device after the beacon frame is transmitted.

In an embodiment, the wireless transceiver is further configured to transmit the beacon extension frame to the second communications device in an Ultra High Reliability (UHR) physical layer protocol data unit (PPDU) when the beacon frame includes a non-delivery traffic indication map (DTIM) beacon frame or transmit the beacon extension frame to the second communications device in a non-High Throughout (HT) PPDU when the beacon frame includes a DTIM beacon frame.

In an embodiment, a wireless access point (AP) compatible with an Institute of Electrical and Electronics Engineers (IEEE) 802.11 protocol includes a controller configured to generate a beacon frame based on Multiple Basic Service Set Identifier (MBSSID) support information and non-Ultra High Reliability (UHR) Station (STA) association allowance information and a wireless transceiver configured to transmit the beacon frame to a second communications device.

In an embodiment, a method for wireless communications includes at a first communications device, generating a beacon frame based on Multiple Basic Service Set Identifier (MBSSID) support information and from the first communications device, wirelessly transmitting the beacon frame to a second communications device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a beacon frame and a beacon extension frame in accordance with an embodiment of the invention.

FIG. 5 depicts a wireless communications system in which an AP wirelessly communicates with wireless stations without multiple BSSID support.

FIG. 6 illustrates a beacon frame in accordance with an embodiment of the invention.

FIG. 7 illustrates a beacon frame in accordance with an embodiment of the invention.

FIG. 8 depicts a wireless communications system in which wireless APs wirelessly communicate with wireless stations with multiple BSSID support.

FIG. 9 illustrates a beacon frame in accordance with an embodiment of the invention.

FIG. 10 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

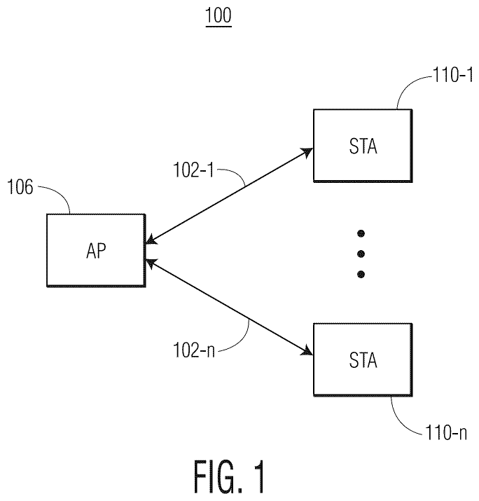

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., EHT communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

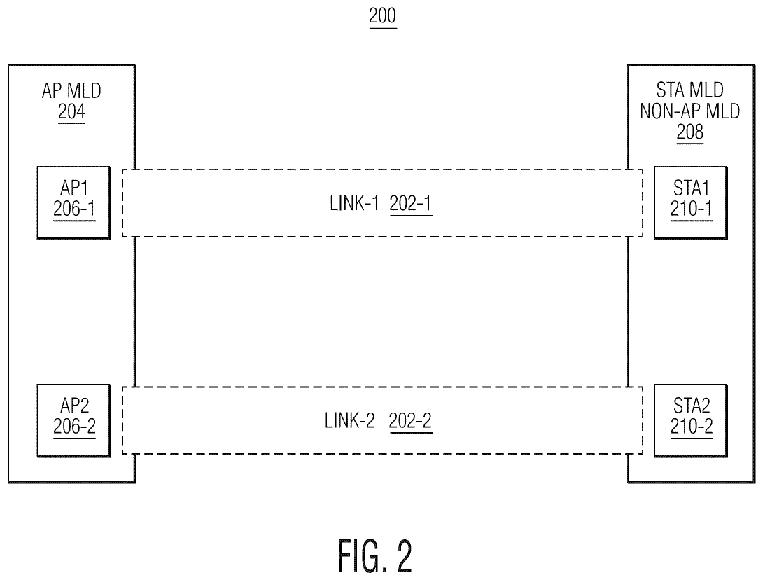

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a beacon frame, a Disassociation frame, an Authentication frame, and/or a Block Acknowledgement (Ack) (BA) Action frame, etc. In some embodiments, one or more management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

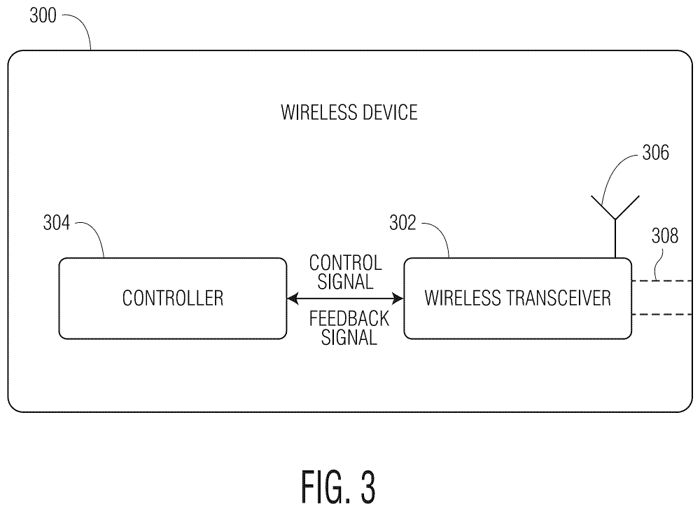

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some cases, a beacon frame or a Probe Response can carry the critical update of a reporting AP, which may be an AP without supporting multiple basic service set identifier (BSSID) that transmits the beacon frame, an AP with transmitted BSSID that transmits the beacon frame, and/or a nontransmitted BSSID AP that is in the same multiple BSSID set as the transmitted BSSID AP that transmits the beacon frame, the channel switch related elements, Quiet element of the reported AP that is affiliated with the same AP MLD as the reporting AP. The reported AP may be on a link other than the link where the beacon frame or the Probe Response is transmitted. The ML Probe Response frame may carry the critical update of the reported AP where the reported AP is affiliated with the same AP MLD as the AP that transmits the ML Probe Response frame or is affiliated with the same AP MLD as a nontransmitted BSSID AP where the nontransmitted BSSID AP is in the same multiple BSSID set as the AP that transmits the ML Probe Response frame.

In some cases, a beacon frame and a beacon extension are used to carry the BSS management information if the beacon frame does not have enough space or capacity to carry all the information. Normally, the beacon extension carries Ultra High Reliability (UHR) related information. If all the association STAs are UHR STAs, the beacon extension can carry High Throughput (HT), Very High Throughput (VHT), High Efficiency (HE), High Throughput (EHT) related information. The basic information can be carried in a beacon frame. The beacon extension (UHR related information) can be optionally transmitted, e.g. when an AP has critical update and the beacon frame does not have enough/sufficient space or capacity to carry the critical update and the other information. Consequently, there is a need for techniques for decreasing the beacon overhead for various AP cases: an AP with or without multiple BSSID support, an AP with non-UHR STA's association being allowed or with UHR STA's association being allowed only.

In accordance with an embodiment of the invention, the controller 304 is configured to generate a beacon frame based on Multiple Basic Service Set Identifier (MBSSID) support information, and the wireless transceiver 302 is configured to wirelessly transmit the beacon frame to a second communications device. In some embodiments, the beacon frame does not carry at least some access point (AP)'s capability and BSS operation information. In some embodiments, the wireless device 300 includes a wireless access point (AP) of a first wireless multi-link device (MLD), and the second communications device includes a wireless non-AP station (STA) of a second wireless MLD. In some embodiments, the controller 304 is further configured to generate the beacon frame based on the MBSSID support information and non-Ultra High Reliability (UHR) Station (STA) association allowance information. In some embodiments, the controller 304 is further configured to generate the beacon frame that includes capability and BSS operation information other than UHR capability information and at least one UHR BSS operating parameter, and an indication whether the communications device supports UHR. In some embodiments, the controller 304 is further configured to generate an indication whether a critical change of UHR BSS operating parameters occurs and a BSS change count related to the critical change of the UHR BSS operating parameters. In some embodiments, the controller 304 is further configured to carry the critical change in beacon frames that include at least one delivery traffic indication map (DTIM) beacon frame. In some embodiments, the controller is further configured to increase the BPCC and to distribute critical update information into beacon frames that include at least one delivery traffic indication map (DTIM) beacon frame, and a critical update flag field in the beacon frames is set to a specific value. In some embodiments, the controller is further configured to generate an indication whether a critical change of UHR BSS operating parameters occurs and a BSS change count related to the critical change of UHR BSS operating parameters. In some embodiments, the controller is further configured to generate the beacon frame that includes BSS management information without UHR information and at least one BSS operating parameter, and UHR support indication information when MBSSID is not supported by the wireless AP, and the BSS management information does not include UHR capability information and UHR BSS operating information. In some embodiments, the controller is further configured to generate the beacon frame that includes basic information when MBSSID is supported by a wireless transmitted BSSID AP of a multiple BSSID set and when non-UHR STA association is not allowed for any AP within the multiple BSSID set, and the basic information includes an SSID element, a supported Rates and BSS Membership Selectors element, a traffic indication map (TIM) element, a security element, a transmit power control element, and critical update indication information and a BSS Parameters Change Count (BPCC). In some embodiments, the controller is further configured to increase the BPCC and to distribute critical update information into beacon frames that include at least one delivery traffic indication map (DTIM) beacon frame, and a critical update flag field in the beacon frames is set to a specific value. In some embodiments, the controller is further configured to generate the beacon frame that includes BSS management information and UHR support indication information when MBSSID is supported by a wireless transmitted BSSID AP of a multiple BSSID set and at least one AP of the multiple BSSID set allows non-UHR STA's association, and the BSS management information does not include UHR capability information and UHR BSS operating information. In some embodiments, the controller is further configured to generate an indication whether a critical change of UHR BSS operating parameters occurs and a BSS change count related to the critical change of the UHR BSS operating parameters, and beacon frames that include at least one delivery traffic indication map (DTIM) beacon frame. In some embodiments, the beacon frame includes a BSS Parameters Change Count (BPCC) of a wireless access point (AP), and when a multi-link device (MLD) associated with the wireless AP has a new critical update, the BPCC is increased and the increased BPCC is carried in each link of the MLD. In some embodiments, the controller is further configured to generate a beacon extension frame based on the MBSSID support information, the beacon extension frame includes multi-link traffic indication information that is not carried in the beacon frame, and the wireless transceiver is further configured to transmit the beacon extension frame to the second communications device after the beacon frame is transmitted. In some embodiments, the wireless transceiver is further configured to transmit the beacon extension frame to the second communications device in an Ultra High Reliability (UHR) physical layer protocol data unit (PPDU) when the beacon frame includes a non-delivery traffic indication map (DTIM) beacon frame or transmit the beacon extension frame to the second communications device in a non-High Throughout (HT) PPDU when the beacon frame includes a DTIM beacon frame. In some embodiments, without considering whether non-UHR STA MLDs are allowed to be associated with an AP of an AP MLD and without considering whether the multiple BSSID is supported, an AP affiliated with the AP MLD (e.g., the controller 304) is further configured to generate the beacon frame with the capabilities, BSS operating information of non-UHR, and an indication of UHR support. In some embodiments, the controller 304 is further configured to increase the BPCC and to distribute critical update information into beacon frames that include at least one delivery traffic indication map (DTIM) beacon frame, and a critical update flag field in the beacon frames is set to a specific value (e.g., 1). In some embodiment, the beacon frame does not carry the UHR critical update information. Instead, if a STA detects the UHR critical update in the AP by finding that its stored BPCC is smaller than the BPCC in the beacon frame, the STA uses a probe procedure to acquire the AP's UHR critical update. Accordingly, the STA records the larger BPCC from the received beacon frame. In some embodiments, without considering whether non-UHR STA MLDs are allowed to be associated with an AP of an AP MLD, an AP affiliated with the AP MLD (e.g., the controller 304) is further configured to generate the beacon frame with the capabilities, operating information of non-UHR, and an indication of UHR support, the critical update related to UHR if the AP has UHR critical update. In some embodiments, the controller 304 is further configured to increase the BPCC and to distribute critical update information into beacon frames that include at least one delivery traffic indication map (DTIM) beacon frame, and a critical update flag field in the beacon frames is set to a specific value (e.g., 1). In some embodiments, the controller 304 is further configured to generate the beacon frame that includes basic information when MBSSID is not supported by a wireless AP and when non-UHR STA association is not allowed by the wireless AP, and the basic information includes an service set identifier (SSID) element, a supported Rates and BSS Membership Selectors element, a traffic indication map (TIM) element, a security element, a transmit power control element, and critical update indication information and a BSS Parameters Change Count (BPCC). In some embodiments, the controller is further configured to increase the BPCC and to distribute critical update information into beacon frames that include at least one delivery traffic indication map (DTIM) beacon frame, and a critical update flag field in the beacon frames is set to a specific value (e.g., 1). In some embodiments, the controller is further configured to generate the beacon frame that includes BSS management information and UHR support indication information when MBSSID is not supported by the wireless AP and the association from non-UHR STA MLDs is allowed, and the BSS management information does not include UHR capability information and UHR BSS operating information. In some embodiments, the controller is further configured to generate the beacon frame that includes basic information when the wireless AP transmitting the beacon frame is the transmitted BSSID AP and when non-UHR STA association is not allowed by all the wireless APs in the multiple BSSID set, and the basic information includes an SSID element, a supported Rates and BSS Membership Selectors element, a TIM element, a security element, a transmit power control element and critical update indication information and a BPCC. In some embodiments, the controller is further configured to increase the BPCC and to distribute critical update information into beacon frames that include at least one delivery traffic indication map (DTIM) beacon frame, and a critical update flag field in the beacon frames is set to a specific value (e.g., 1). In some embodiments, the controller is further configured to generate the beacon frame that includes BSS management information (e.g., capabilities and BSS operating information), and UHR support indication information when MBSSID is supported by the wireless AP and when non-UHR STA association is allowed by at least one of the wireless APs in the multiple BSSID set, and the BSS management information does not include UHR capability information and UHR BSS operating information. In some embodiments, the beacon frame includes a BPCC of a wireless access point (AP). In some embodiments, when a multi-link device (MLD) associated with the wireless AP has a new critical update, the BPCC is increased and the increased BPCC is carried in each link of the MLD. In some embodiments, if the beacon frame does not have sufficient space or capacity to carry all the information, the controller is further configured to generate a beacon extension frame based on the MBSSID support information, and the wireless transceiver is further configured to transmit the beacon extension frame to the second communications device after the beacon frame is transmitted. In some embodiments, the beacon extension frame includes multi-link traffic indication information that is not carried in the beacon frame. In some embodiments, the wireless transceiver is further configured to transmit the beacon extension frame to the second communications device in a UHR physical layer protocol data unit (PPDU). In some embodiments, the wireless transceiver is further configured to transmit the beacon extension frame to the second communications device in a UHR PPDU when the beacon frame includes a non-DTIM beacon frame or transmit the beacon extension frame to the second communications device in a non-High Throughout (HT) PPDU when the beacon frame includes a DTIM beacon frame. In some embodiments, the communications device includes a wireless device that is compatible with an Institute of Electrical and Electronics Engineers (IEEE) 802.11 protocol. In some embodiments, the wireless device includes a wireless AP that is compatible with the IEEE 802.11 protocol. In some embodiments, the communications device includes a wireless multi-link device (MLD), the second communications device includes a second wireless MLD, and the wireless transceiver is further configured to transmit the beacon frame to the second wireless MLD through a wireless link between the wireless MLD and the second wireless MLD.

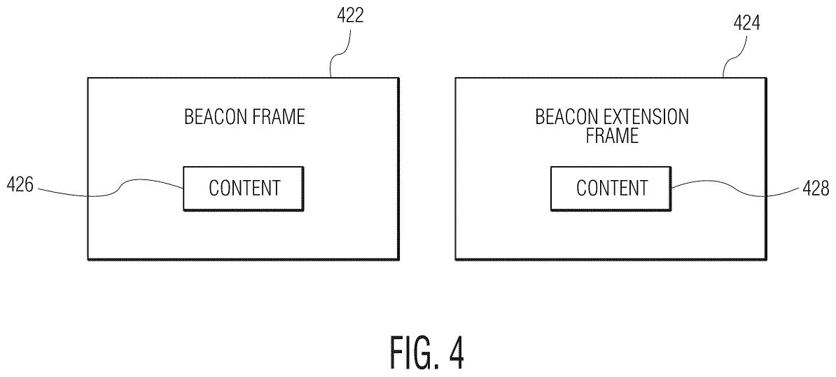

FIG. 4 depicts a beacon frame 422 and a beacon extension frame 424 in accordance with an embodiment of the invention. The beacon frame 422 and the beacon extension frame 424 may be transmitted from an AP (e.g., the AP 106 depicted in FIG. 1 and/or the AP 206-1 or 206-2 depicted in FIG. 2) to a number of non-AP STAs (e.g., the at least one STA 110-1, . . . , 110-n depicted in FIG. 1 and/or the STAs 210-1 and 210-2 depicted in FIG. 2). In the embodiment depicted in FIG. 4, the beacon extension frame 424, which includes content 426 (for example, information that cannot be included in the beacon frame 422 (e.g., Multi-Link Traffic Indication information)), follows the beacon frame 422, which includes content 428. In some embodiments, the beacon frame 422 carries or contains an indication that the beacon extension frame 424 follows the beacon frame 422. The beacon extension frame can be transmitted after the beacon frame is transmitted. In some embodiments, instead of the beacon extension frame 424, a broadcast management frame (e.g., a Probe Response frame) follows the beacon frame 422 and is transmitted to non-AP STAs after the beacon frame is transmitted to the non-AP STAs. In these embodiments, the beacon frame carries or contains an indication that the broadcast management frame follows the beacon frame.

In some embodiments, if/when an AP of an AP MLD in a link does not support multiple BSSID feature, the AP transmits its beacon frame. The AP, which carries the Multiple BSSID element in its beacon frame, is known as the “Transmitted BSSID AP (the AP whose BSSID is transmitted BSSID),” and the AP, whose information is carried by nontransmitted BSSID profile in the Multiple BSSID element, is known as the “non-transmitted BSSID AP (AP whose BSSID is nontransmitted BSSID).” In some embodiments, if/when an AP of an AP MLD in a link is a transmitted BSSID AP, the AP transmits its beacon frame while the non-transmitted BSSID APs in the same multiple BSSID set as the transmitted BSSID AP do not transmit their beacon frames.

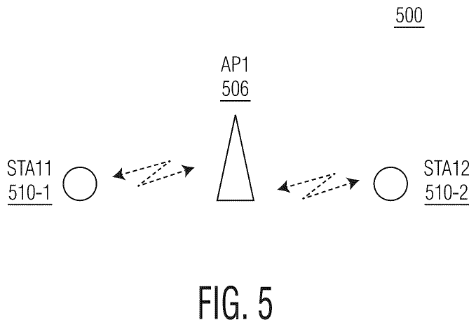

FIG. 5 depicts a wireless communications system 500 in which an AP 506 (AP1) wirelessly communicates with wireless stations 510-1 (STA11), 510-2 (STA12) without multiple BSSID support. AP1 may be an embodiment of the AP 106 depicted in FIG. 1 and/or the AP 206-1 or 206-2 depicted in FIG. 2, STA 11, STA12 may be embodiments of the STAs 110-1, . . . , 110-n depicted in FIG. 1 and/or the STAs 210-1 and 210-2 depicted in FIG. 2. AP1, STA 11, STA12 may be implemented similarly to or the same as the wireless device 300 depicted in FIG. 3. In the embodiment depicted in FIG. 5, the wireless communications system 500 (e.g., AP1) does not support multiple BSSID and there are no other APs in the same wireless communications system.

Some implementations of beacon optimization without multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5 are described. In some embodiments, a beacon frame is used to carry BSS management information other than the UHR (e.g., IEEE 802.11bn) information (e.g., UHR capabilities, UHR BSS operating information). In some embodiments, an indication is carried in the beacon frame to indicate whether an AP transmitting the beacon supports the UHR. In some embodiments, a STA uses a Probe Request to solicit UHR information of an AP supporting UHR. In some embodiments, critical update indication and BSS Parameters Change Count (BPCC) information of a reporting AP and reported APs are specific to UHR related critical update as option 1 or IEEE 802.11be defined critical update indication and BPCC as option 2. A beacon extension frame may also be required if a beacon frame cannot carry all the information, e.g., when the Multi-Link Traffic Indication needs to be carried. In some embodiments, when an AP has critical information change related to UHR information, the AP transmits a beacon frame with the UHR critical update, e.g., UHR operating parameter change. With this approach, the transmission of the Probe Request after the UHR critical update can be avoided. In another variant, the beacon frame does not carry the UHR critical update and a UHR STA uses a probe procedure to acquire an AP's UHR critical update.

Some implementations of critical update of a reporting AP without multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5 are described. In some embodiments, if a reporting AP increases the BSS Parameters Change Count (BPCC) for its Critical update related to a UHR protocol, the beacon frame carries the critical update if the beacon frame's length allows such inclusion. In some embodiments, if a reporting AP increases the BPCC for its Critical update related to a UHR protocol, the beacon extension frame or a Probe Response frame carries the critical update if the beacon frame's length does not allow such inclusion. In some embodiments, the Critical update Flag is set to 1 for the BPCC in several beacons where the beacon extension frame (or a Probe Response) that carries the UHR critical update follows one such beacon frame and at least one beacon frame is a delivery traffic indication map (DTIM) beacon frame.

Some implementations of basic information in beacon frame without multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5 are described.

In Option 1, when all the associated STAs are UHR STAs, an AP can select to transmit a beacon frame with basic information. In some embodiments, the basic information includes SSID element, supported rates and BSS membership selectors element, traffic indication map (TIM) element, elements related to security, multi-link traffic indication element if Traffic Identifier (TID)-to-link mapping of TID-to-Link mapping mode 3 is negotiated, elements related to transmit power control, and/or critical indication and BPCC information of a reporting AP and reported APs, which can be specific to UHR related critical update as option 1 or IEEE 802.11be defined critical update indication and BPCC as option 2. In some embodiments, when an AP has critical information change, the AP transmits a beacon frame with the detailed information of the critical update. With this approach, the transmission of the Probe Request after the critical update can be avoided. In another variant, the beacon frame does not carry the critical update. A UHR STA may use probe procedure to acquire an AP's critical update.

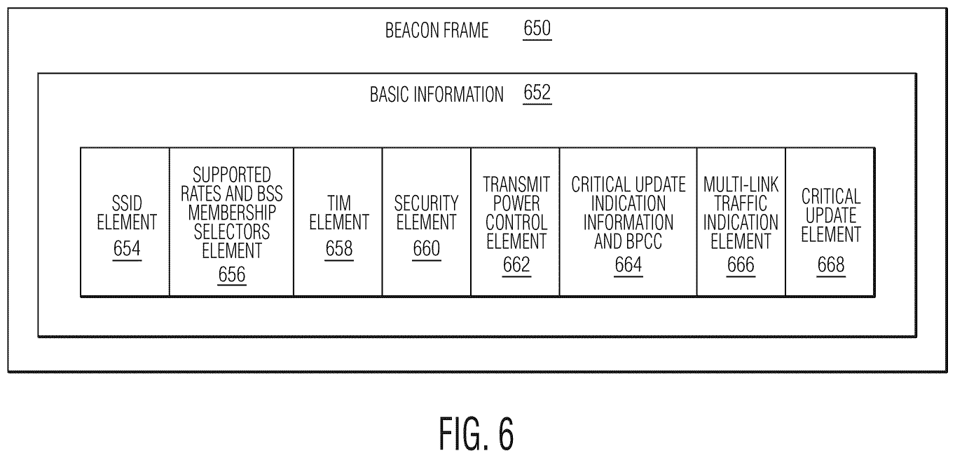

FIG. 6 illustrates a beacon frame 650 in accordance with an embodiment of the invention. The beacon frame 650 illustrated in FIG. 6 can be used for communications by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5. In the embodiment depicted in FIG. 6, the beacon frame 650 includes basic information 652 (e.g., when MBSSID is not supported by a wireless AP and when non-UHR STA association is not allowed by the wireless AP), which includes an SSID element 654 that may contain SSID information, a supported Rates and BSS Membership Selectors element 656 that may contain information regarding supported transmission Rates and BSS Membership selection information, a traffic indication map (TIM) element 658 that may contain TIM information, a security element 660 that may contain security information, a transmit power control element 662 that may contain transmit power control information, and critical update indication information and a BSS Parameters Change Count (BPCC) 664. In some embodiments, the basic information 652 also includes a multi-link traffic indication element 666 if TID-to-link mapping of TID-to-Link mapping mode is negotiated. In some embodiments, the basic information 652 also includes a critical update element 668 that includes detailed information of a critical update. In some embodiments, the BPCC is increased and critical update information is distributed into multiple beacon frames that include at least one delivery traffic indication map (DTIM) beacon frame, and a critical update flag field in the beacon frames is set to a specific value (e.g., 1).

In Option 2, a beacon frame is used to carry the BSS management information other than the UHR (e.g., IEEE 802.11bn) information (e.g., UHR capabilities and/or UHR BSS operating information). In some embodiments, an Indication is carried in a beacon frame to indicate whether the AP transmitting the beacon frame supports UHR. In some embodiments, a STA uses a Probe Request to solicit the UHR detail information of an AP supporting UHR. In some embodiments, critical update indication and BPCC information of a reporting AP and reported APs can be specific to UHR related critical update as option 1 or IEEE 802.11be defined critical update indication and BPCC as option 2. In some embodiments, when an AP has critical information change related to UHR information, the AP transmits a beacon frame with the detail information of the UHR critical update. With this approach, the transmission of a Probe Request after the UHR critical update can be avoided.

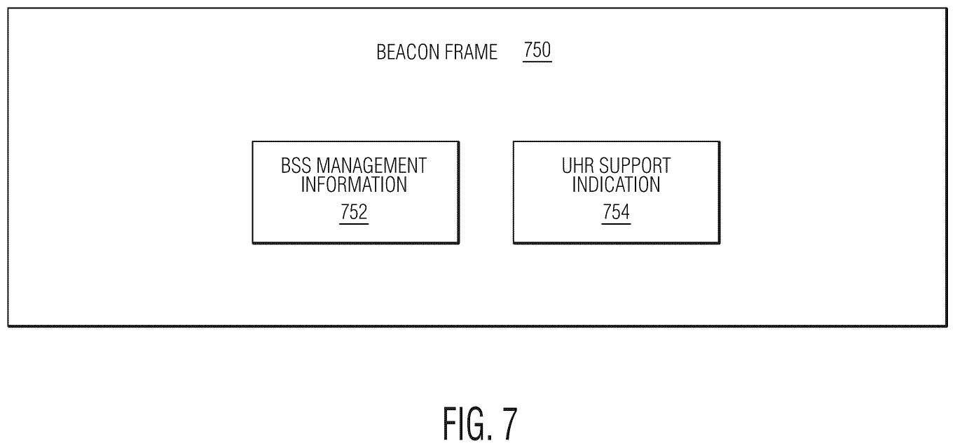

FIG. 7 illustrates a beacon frame 750 in accordance with an embodiment of the invention. The beacon frame 750 illustrated in FIG. 7 can be used for communications by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5. In the embodiment depicted in FIG. 7, the beacon frame 750 includes BSS management information 752 (e.g., when MBSSID is not supported by a wireless AP and when non-UHR STA association may be allowed by the wireless AP) and UHR Support Indication 754. In some embodiments, BSS management information does not include UHR (e.g., IEEE 802.11bn) information (e.g., UHR capabilities, UHR BSS operating information). In some embodiments, the UHR Support Indication 754 indicates whether an AP transmitting the beacon frame 750 supports UHR.

Some implementations of critical update of a reporting AP without multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 500 depicted in FIG. 5 are described.

In critical update of light beacon Option 1, an AP only allows the associations from the UHR STAs as described below. In some embodiments, if/when a reporting AP increases the BPCC for its Critical update, the following procedures are performed. In some embodiments, the critical update information of the BPCC is included or contained in several beacon frames where at least one beacon frame is a DTIM beacon frame and the Critical update Flag field in the beacon frames is set to 1 for the BPCC. In such case, the beacon frame carries the basic information and the critical update information related to the BPCC. In some embodiments, if the Critical update Flag in a beacon frame switches back to 0, the critical update information of the BPCC is not carried in the beacon frame. In such case, the beacon frame only carries the basic information (e.g., TIM, SSID security information, Multi-Link Traffic Indication etc.).

In critical update of light beacon Option 2, an AP only allows the associations from the UHR STAs as described below. In some embodiments, if/when a reporting AP increases the BPCC for its Critical update related to non-UHR protocol(s), the beacon frame carries the critical update anyway. In some embodiments, the Critical update Flag is set to 1 for the BPCC in several beacon frames where at least one beacon frame is a DTIM beacon frame. In some embodiments, if a reporting AP increases the BPCC for its Critical update related to UHR protocol(s), the following procedures are performed. In some embodiments, if/when a beacon frame's length allows the carrying of the critical update, the Critical update Flag being set to 1 for the newest BPCC value is carried in several beacon frames where at least one beacon frame is a DTIM beacon frame and each such beacon frame carries the Critical update related to the new BPCC value. In some embodiments, if/when the beacon frame's length does not allow the carrying of the critical update, the beacon extension frame or the unsolicited Probe Response is used to carry the critical update. In some embodiments, if/when the Critical update Flag in a beacon frame switches back to 0, the critical update information of the BPCC is not carried in the beacon frame.

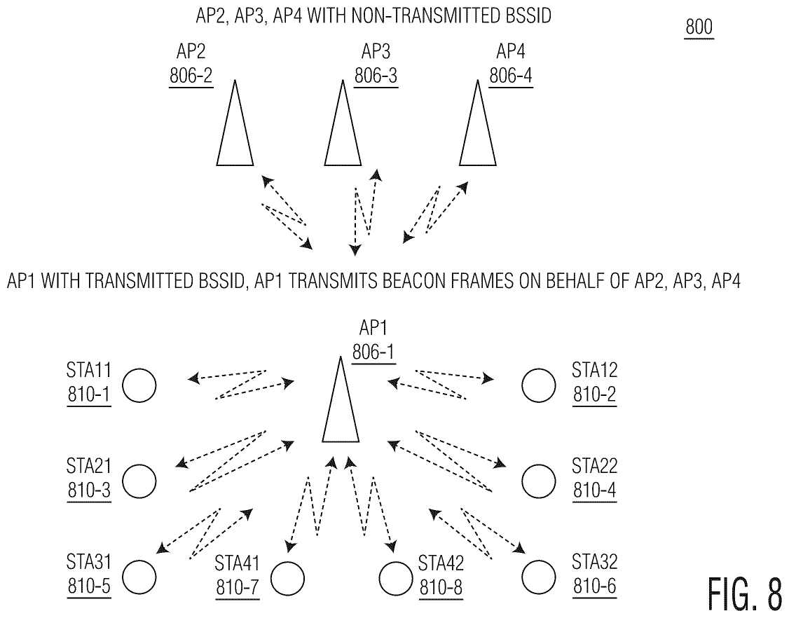

FIG. 8 depicts a wireless communications system 800 in which APs 806-1 (AP1), 806-2 (AP2), 806-3 (AP3), 806-4 (AP4) wirelessly communicate with wireless stations 810-1 (STA11), 810-2 (STA12), 810-3 (STA21), 810-4 (STA22), 810-5 (STA31), 810-6 (STA32), 810-7 (STA41), 810-8 (STA42) with multiple BSSID support. AP1, AP2, AP3, AP4 may be embodiments of the AP 106 depicted in FIG. 1 and/or the AP 206-1 or 206-2 depicted in FIG. 2, STA 11, STA12, STA 21, STA22, STA 31, STA32, STA 41, STA42 may be embodiments of the STAs 110-1, . . . , 110-n depicted in FIG. 1 and/or the STAs 210-1 and 210-2 depicted in FIG. 2. AP1, AP2, AP3, AP4, STA 11, STA12, STA 21, STA22, STA 31, STA32, STA 41, STA42 may be implemented similarly to or the same as the wireless device 300 depicted in FIG. 3. In the embodiment depicted in FIG. 8, the wireless communications system 800 (e.g., AP1, AP2, AP3, AP4) supports multiple BSSID and AP1 uses different SSIDs to communicate with STA12, STA 21, STA22, STA 31, STA32, STA 41, STA42. In the embodiment depicted in FIG. 8, each of AP2, AP3, AP4 has a non-transmitted BSSID and AP1 transmits beacon frames on behalf of AP2, AP3, AP4.

Some implementations of beacon optimization with multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 800 depicted in FIG. 8 are described. In option 1, in some embodiments, without considering whether non-UHR STAs are allowed to be associated with APs of a multiple BSSID set, a beacon frame is used to carry the BSS management information other than the UHR (IEEE 802.11bn) information (e.g., UHR capabilities and/or UHR BSS operating information) of the APs in multiple BSSID AP set. In some embodiments, an Indication is carried in the beacon frame to indicate whether each of the AP transmitting the beacon and the non-transmitted BSSID APs supports UHR. In some embodiments, a STA uses a Probe Request to solicit the UHR detail information of an AP supporting UHR. In some embodiments, critical update indication and BPCC information of a reporting AP (e.g., transmitted BSSID AP and non-transmitted BSSID AP respectively in the link where the beacon frame is transmitted) and reported APs (e.g., the APs affiliated with the same AP MLDs as the APs in the multiple BSSID set) can be specific to UHR related critical update as option 1 or IEEE 802.11be defined critical update indication and BPCC as option 2. In some embodiments, when an AP (transmitted BSSID AP or non-transmitted BSSID AP) has critical information change related to UHR information, the transmitted BSSID AP transmits a beacon frame with the detail information of the UHR critical update of the related AP. With this approach, the transmission of a Probe Request after the UHR critical update can be avoided. In another variant, the beacon frame does not carry the UHR critical update and a UHR STA uses a probe procedure to acquire the AP's UHR critical update.

Some implementations of critical update of a reporting AP with multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 800 depicted in FIG. 8 are described. In some embodiments, a beacon frame includes the information required for an EHT STA's association and frame exchanges, e.g., all HT (per the band of the AP is working on), VHT (per the band of the AP is working on), HE, EHT Capabilities elements, and all HT (per the band of the AP is working on), VHT (per the band of the AP is working on), HE, EHT Operation elements.

In some embodiments, if/when the transmitted BSSID AP increases the BPCC for its Critical update related to non-UHR protocol(s), the beacon frame carries the critical update anyway. In some embodiments, the Critical update Flag is set to 1 for the BPCC in several beacon frames where at least one beacon frame is a DTIM beacon frame.

In some embodiments, if/when the transmitted BSSID AP increases the BPCC for its Critical update related to UHR protocol(s), the following are truc. If the beacon frame's length allows the carrying of the critical update, the Critical update Flag being set to 1 for the newest BPCC value are carried in several beacon frames where at least one beacon frame is a DTIM beacon and each such beacon frame carries the Critical update related to the new BPCC value. Otherwise, the Critical update Flag being set to 1 for the newest BPCC value is carried in several beacon frames where at least one beacon frame is a DTIM beacon frame and each beacon extension frame or unsolicited Probe Response frame that follows one of such beacon frame carries the Critical update related to the new BPCC value. If/when the Critical update Flag in a beacon frame switches back to 0, the critical update information of the BPCC is not carried in the beacon frame.

In some embodiments, the nontransmitted BSSID Profile is related to a nontransmitted BSSID AP, the beacon frame includes the information required for the EHT STA's association and frame exchanges. In some embodiments, if/when the nontransmitted BSSID AP increases the BPCC for its Critical update related to non-UHR protocol(s), the beacon frame carries the critical update anyway. In some embodiments, the Critical update Flag is set to 1 for the BPCC in several beacon frames where at least one beacon frame is a DTIM beacon frame of the nontransmitted BSSID AP.

In some embodiments, if/when the nontransmitted BSSID AP increases the BPCC for its Critical update related to UHR protocol(s), the following are true. If/when the beacon frame's length allows the carrying of the critical update, the Critical update Flag being set to 1 for the newest BPCC value is carried in several beacon frames where at least one beacon frame is a DTIM beacon frame and each such beacon frame carries the Critical update related to the new BPCC value. Otherwise, the Critical update Flag being set to 1 for the newest BPCC value is carried in several beacon frames where at least one beacon frame is a DTIM beacon frame and each beacon extension frame or unsolicited Probe Response frame that follows one of such beacon frame carries the Critical update related to the new BPCC value. If/when the Critical update Flag in a beacon frame switches back to 0, the critical update information of the BPCC is not carried in the beacon frame.

In option 2, some implementations of basic information in beacon frame with multiple BSSID support, for example, by the wireless communications system 100 depicted in FIG. 1, the multi-link (ML) communications system 200 depicted in FIG. 2, the wireless device 300 depicted in FIG. 3, and/or the wireless communications system 800 depicted in FIG. 8 are described.

In case 1 of Option 2, when all the associated STAs with the APs of the multiple BSSID set are UHR STAs, an AP can select to transmit the beacon frame only with the beacon frame to carry the basic information where the basic information includes SSID element, supported rates and BSS membership selectors element, TIM element, elements related to security, multi-link traffic indication element if TID-to-link mapping of TID-to-Link mapping mode 3 is negotiated, elements related to transmit power control, and/or critical indication and BPCC information of a reporting AP (transmitted BSSID AP or non-transmitted BSSID AP respectively) and reported APs, which can be specific to UHR related critical update as option 1 or IEEE 802.11be defined critical update indication and BPCC as option 2. In some embodiments, when an AP has critical information change, the transmitted BSSID AP transmits the beacon frame with the detail information of the critical update of the related AP. With this approach, the transmission of the Probe Request after the UHR critical update can be avoided.

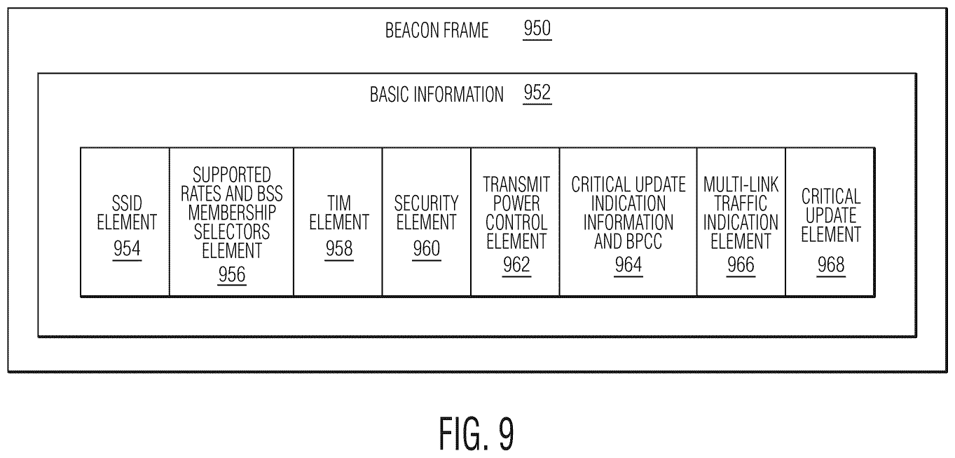

FIG. 9 illustrates a beacon frame 950 in accordance with an embodiment of the invention. The beacon frame 950 illustrated in FIG. 9 can be used for communications by the wireless communications system 100 depicted in FIG. 1, the multi-link (ML) communications system 200 depicted in FIG. 2, the wireless device 300 depicted in FIG. 3, and/or the wireless communications system 800 depicted in FIG. 8. In the embodiment depicted in FIG. 9, the beacon frame 950 includes basic information 952 (e.g., when MBSSID is supported by a wireless transmitted BSSID AP of a multiple BSSID set and when non-UHR STA association is not allowed by each wireless AP in the multiple BSSID set), which includes an SSID element 954 that may contain SSID information, a supported Rates and BSS Membership Selectors element 956 that may contain information regarding supported transmission Rates and BSS Membership selection information, a traffic indication map (TIM) element 958 that may contain TIM information, a security element 960 that may contain security information, a transmit power control element 962 that may contain transmit power control information, and critical update indication information and a BSS Parameters Change Count (BPCC) 964. In some embodiments, the basic information 652 also includes a multi-link traffic indication element 666 if TID-to-link mapping of TID-to-Link mapping mode is negotiated. In some embodiments, the basic information 952 also includes a critical update element 968 that includes detailed information of a critical update. In some embodiments, when an AP has critical information change, the transmitted BSSID AP transmits the beacon frame with the detail information of the critical update of the related AP.

In case 2 of Option 2, if at least one AP of a multiple BSSID set allows non-UHR STA's association, the beacon frame of the multiple BSSID set is used to carry the BSS management information other than the UHR (IEEE 802.11bn) information (e.g., UHR capabilities, UHR BSS operating information). In some embodiments, an indication is carried in a beacon frame to indicate whether the AP transmitting the beacon frame supports UHR. The beacon frame may be implemented similarly to or the same as the beacon frame 750 depicted in FIG. 7. In some embodiments, a STA uses a Probe Request to solicit the UHR detail information of an AP supporting UHR. In some embodiments, critical update indication and BPCC information of a reporting AP (transmitted BSSID AP or non-transmitted BSSID AP respectively of the multiple BSSID set) and reported APs affiliated with the same AP MLDs as the APs of the multiple BSSID set can be specific to UHR related critical update as option 1 or IEEE 802.11be defined critical update indication and BPCC as option 2. In some embodiments, when an AP has critical information change related to UHR information, the transmitted BSSID AP transmits the beacon frame with the detail information of the UHR critical update of the related AP. With this approach, the transmission of the Probe Request after the UHR critical update can be avoided.

Some implementations of critical update of a reporting AP with multiple BSSID support, for example, by the wireless communications system 100 depicted in FIG. 1, the multi-link (ML) communications system 200 depicted in FIG. 2, and/or the wireless device 300 depicted in FIG. 3 are described.

In critical update of light beacon case 1 of option 2, all the APs in the multiple BSSID set only allow the associations from UHR STAs. One or more of the following procedures can be performed for or apply to the transmitted BSSID AP.

In some embodiments, the beacon frame without the new critical update includes the basic information (TIM, SSID, security related information, Multi-Link Traffic Indication based on whether a STA has different TIDs being mapped to different links) only.

In some embodiments, if/when the transmitted BSSID AP increases the BPCC for its Critical update related to non-UHR protocol(s), the beacon frame carries the critical update related to the newest BPCC value. In some embodiments, the critical update information of the BPCC are included or carried in several beacon frames where at least one beacon frame is a DTIM beacon frame and the Critical update Flag field in the beacon frames is set to 1 for the BPCC. In some embodiments, if/when the Critical update Flag in a beacon frame switches back to 0, the critical update information of the BPCC is not carried in the beacon.

In some embodiments, if the transmitted BSSID AP increases the BPCC for its Critical update related to UHR protocol(s), the beacon frame carries the critical update related to the newest BPCC value. In some embodiments, the critical update information of the BPCC are included or carried in several beacon frames where at least one beacon frame is a DTIM beacon frame and the Critical update Flag field in the beacon frames is set to 1 for the BPCC. In some embodiments, if/when the Critical update Flag in a beacon frame switches back to 0, the critical update information of the BPCC is not carried in the beacon frame.

In some embodiments, the beacon frame includes the information required for the EHT STA's association and frame exchanges, e.g. all HT (per the band of the AP is working on), VHT (per the band of the AP is working on), HE, EHT Capabilities elements, and all HT (per the band of the AP is working on), VHT (per the band of the AP is working on), HE, EHT Operation elements,

In some embodiments, if/when the transmitted BSSID AP increases the BPCC for its Critical update related to non-UHR protocol(s), the beacon frame carries the critical update anyway. In some embodiments, the Critical update Flag is set to 1 for the BPCC in several beacon frames where at least one beacon frame is a DTIM beacon frame.

In some embodiments, if/when the transmitted BSSID AP increases the BPCC for its Critical update related to UHR protocol(s), the following are true. If/when the beacon frame's length allows the carrying of the critical update, the Critical update Flag being set to 1 for the newest BPCC value is carried in several beacon frames where at least one beacon frame is a DTIM beacon frame and each such beacon frame carries the Critical update related to the new BPCC value. Otherwise, the Critical update Flag being set to 1 for the newest BPCC value are carried in several beacon frames and beacon extensions (unsolicited Probe Response frames) where at least one beacon frame is a DTIM beacon frame and each beacon extension frame or unsolicited Probe Response frame that follows one of such beacon frame carries the Critical update related to the new BPCC value. In some embodiments, if/when the Critical update Flag in a beacon frame switches back to 0, the critical update information of the BPCC is not carried in the beacon frame.

One or more of the following procedures can be performed for or apply to a nontransmitted BSSID AP.

In some embodiments, the nontransmitted BSSID profile of the nontransmitted BSSID AP carries the basic information only (SSID, security related information) if the nontransmitted BSSID AP has no critical update.

In some embodiments, if/when the nontransmitted BSSID AP increases the BPCC for its Critical update related to non-UHR protocol(s), the beacon frame (i.e. the nontransmitted BSSID profile in the beacon frame) carries the critical update related to the newest BPCC value. In some embodiments, the critical update information of the BPCC are included or carried in several beacon frames where at least one beacon frame is a DTIM beacon frame and the Critical update Flag field in the beacon frames is set to 1 for the BPCC. In some embodiments, if/when the Critical update Flag in a beacon frame switches back to 0, the critical update information of the BPCC is not carried in the beacon frame.

In some embodiments, if/when the nontransmitted BSSID AP increases the BPCC for its Critical update related to UHR protocol(s), the beacon frame (i.e. the nontransmitted BSSID profile in the beacon frame) carries the critical update related to the newest BPCC value except if the beacon length does not allow such inclusion the beacon extension frame or the unsolicited Probe Response carries the related critical update. In some embodiments, the critical update information of the BPCC are included or carried in several beacon frames where at least one beacon frame is a DTIM beacon frame and the Critical update Flag field in the beacon frames is set to 1 for the BPCC. In some embodiments, if/when the Critical update Flag in a beacon frame switches back to 0, the critical update information of the BPCC is not carried in the beacon frame.

In some embodiments, the nontransmitted BSSID Profile related to nontransmitted BSSID AP the beacon frame includes the information required for the EHT STA's association and frame exchanges,

In some embodiments, if/when the nontransmitted BSSID AP increases the BPCC for its Critical update related to non-UHR protocol(s), the beacon frame carries the critical update anyway. In some embodiments, the Critical update Flag is set to 1 for the BPCC in several beacon frames where at least one beacon frame is a DTIM beacon frame of the nontransmitted BSSID AP.

In some embodiments, if/when the beacon frame's length allows the carrying of the critical update, the Critical update Flag being set to 1 for the newest BPCC value are carried in several beacon frames where at least one beacon frame is a DTIM beacon frame and each such beacon frame carries the Critical update related to the new BPCC value. Otherwise, the Critical update Flag being set to 1 for the newest BPCC value is carried in several beacon frames where at least one beacon frame is a DTIM beacon frame and each beacon extension frame or unsolicited Probe Response frame that follows one of such beacon frame carries the Critical update related to the new BPCC value. In some embodiments, if/when the Critical update Flag in a beacon frame switches back to 0, the critical update information of the BPCC is not carried in the beacon frame.

In some implementations, some STAs wake up at each Target Beacon Transmission Time (TBTT) for the beacon reception to decide whether an AP has buffered unicast frames for it. Some STAs wake up at each DTIM TBTT for the DTIM beacon reception to decide whether the AP has the broadcast frame and buffered unicast frames for it. Some low power STAs may skip the DTIM beacons for long sleep time. Such STAs may negotiate the listen interval to let the AP know when the STA will wake up for its beacon reception.

In some implementations, in order to reduce the beacon overhead, a UHR AP that does not allow the non-UHR STAs to associate with it may transmit the basic information (e.g., Nontransmitted BSSIDs, Critical Update Flag, SSID, security related information, TIM, and/or Multi-Link Traffic Indication) in its beacon. The UHR information (e.g., UHR capabilities, UHR operating parameters) may not be carried in a beacon frame. When the critical update occurs at an AP, the AP uses a beacon frame or/and a Probe Response to transmit its critical update or the critical update of another AP that is affiliated with the same AP MLD as the AP. An extreme power save STA may miss the critical update and the light beacon decoding cannot help a STA's acquiring of an AP's critical update.

Some implementations of full AP information acquiring through BPCC, for example, by the wireless communications system 100 depicted in FIG. 1, the multi-link (ML) communications system 200 depicted in FIG. 2, and/or the wireless device 300 depicted in FIG. 3 are described. In some embodiments, a light beacon carries the BPCC of the reported APs and a reporting AP. The BPCC can be UHR specific BPCC or BPCC defined by IEEE 802.11be. In some embodiments, when a reporting AP or a reported AP affiliated with an AP MLD has a new critical update, the increased BPCC of the AP is carried in each link of the AP MLD. In some embodiments, when an AP MLD has a new critical update, the BPCC of each AP affiliated with the AP MLD is increased and the increased BPCC is carried in each link of the AP MLD. In some embodiments, when an extreme low power non-AP MLD detects an increased BPCC of an AP in its setup links, the non-AP MLD record the increased BPCC uses the probe procedure to acquire the critical update.

Some implementations of AP critical update information acquiring indication, for example, by the wireless communications system 100 depicted in FIG. 1, the multi-link (ML) communications system 200 depicted in FIG. 2, and/or the wireless device 300 depicted in FIG. 3 are described. In some embodiments, a new one-bit field, AP Critical Update Information Acquiring Indication (ACUIAI) field, is defined to indicate whether an extreme power save associated STA needs to acquire an AP's critical update. In some embodiments, the ACUIAI field is carried in Capability Information and Status Indication field. In some embodiments, the AP Critical Update Information Acquiring Indication (ACUIAI) field is also used to indicate whether an extreme power save associated non-AP MLD needs to acquire the AP MLD's critical update and affiliated APs' critical update if the non-AP MLD is associated with the AP MLD with which the AP that transmits the ACUIAI is affiliated. In some embodiments, the AP that transmits the beacon frame with ACUIAI field is the transmitted BSSID AP or the AP that does not support multiple BSSID feature. In some embodiments, when the AP or any AP that is affiliated with the same AP MLD as the AP has critical update, the AP has its ACUIAI field in its light beacon being equal to 1 for the longest listen interval among the associated non-AP MLDs. In some embodiments, after the longest listen interval, the AP has its ACUIAI field in its light beacon being equal to 0. In some embodiments, when a STA affiliated with a non-AP MLD that negotiates a listen interval longer than a DTIM beacon interval receives a light beacon with ACUIAI equal to 1 and the non-AP MLD is associated with the AP MLD with which the AP that transmits ACUIAI is affiliated, the non-AP MLD needs to get the newest information of its associated AP MLD and the newest information of the APs affiliated with its associated AP MLD. In some embodiments, the Probe procedure can be used, i.e., a Probe Request and/or an ML Probe Request are used. In some embodiments, when a STA that negotiates a listen interval longer than DTIM beacon interval receives a light beacon with ACUIAI equal to 1, the STA needs to get the newest information of its associated AP. In some embodiments, the Probe procedure can be used, i.e., a Probe Request is used. In some embodiment, the ACUIAI field with initial value 0 is a counter (instead of a one-bit indication) where each time a critical update happens, the ACUIAI field is increased by 1.

Some implementations of AP critical update information acquiring indication under multiple BSSID, for example, by the wireless communications system 100 depicted in FIG. 1, the multi-link (ML) communications system 200 depicted in FIG. 2, and/or the wireless device 300 depicted in FIG. 3 are described. In some embodiments, a new one-bit field, Nontransmitted BSSIDs AP Critical Update Information Acquiring Indication (NBACUIAI) field for nontransmitted BSSID APs, is defined to indicate whether an extreme power save STA associated with one nontransmitted BSSID AP needs to acquire an AP's critical update. In some embodiments, the AP Critical Update Information Acquiring Indication field is carried in Capability Information and Status Indication field as an example. In some embodiments, NBACUIAI field is also used to indicate whether an extreme power save non-AP MLD associated with an AP MLD whose affiliated AP in the link is nontransmitted BSSID AP needs to acquire the AP MLD's critical update and affiliated APs' critical update. In some embodiments, when 1), an AP has nontransmitted BSSID and 2), an AP or any AP that is affiliated with the same AP MLD as the AP has critical update, the transmitted BSSID AP has its NBACUIAI field in its light beacon being equal to 1 for the longest listen interval among the associated non-AP MLDs. In some embodiments, after the longest listen interval, the AP has its NBACUIAI field in its light beacon being equal to 0. In some embodiments, when a STA affiliated with a non-AP MLD that negotiates a listen interval longer than DTIM beacon interval receives a light beacon with NBACUIAI equal to 1 and the non-AP MLD is associated with the AP MLD whose affiliated AP in the link is nontransmitted BSSID AP, the non-AP MLD needs to get the newest information of its associated AP MLD and the newest information of the APs affiliated with its associated AP MLD. In some embodiments, the Probe procedure can be used, i.e., a Probe Request and/or a ML Probe Request are used. Because NBACUIAI is for multiple nontransmitted BSSID APs and their affiliated AP MLDs, an AP MLD with affiliated nontransmitted BSSID AP may have no critical update when the NBACUIAI in the beacon is equal to 1. In some embodiments, when a STA that negotiates a listen interval longer than DTIM beacon interval with its associated nontransmitted BSSID AP receives a light beacon with NBACUIAI equal to 1, the STA needs to get the newest information of its associated AP. In some embodiments, the Probe procedure can be used, i.e., a Probe Request is used. Instead of defining a single NBACUIAI field for multiple AP MLDs with affiliated nontransmitted BSSD APs, another variant is to define the different NBACUIAI fields for different AP MLDs with affiliated nontransmitted BSSID APs. In some embodiments, if/when at least one AP affiliated with the same AP MLD as a nontransmitted BSSID AP, the NBACUIAI related to the AP MLD with which the nontransmitted BSSID AP is affiliated is set to 1, and the time when the related NBACUIAI is equal to 1 is no less than the maximal listen interval negotiated by all the non-AP MLDs that are associated with the AP MLD. In some embodiments, a non-AP MLD associated with the AP MLD uses the probe procedure to acquire the critical update of the critical update. In another solution, instead of using ACUIAI and NBACUIAI, one field ACUIAI in a link is used for all the AP MLDs with affiliated APs in the same multiple BSSID set to announce whether at least one of them has the critical update. In some embodiment, the NBACUIAI field with initial value 0 is a counter (instead of a one-bit indication) where each time a critical update happens, the NBACUIAI field is increased by 1.

Some implementations of beacon extension frames in UHR PPDU, for example, by the wireless communications system 100 depicted in FIG. 1, the multi-link (ML) communications system 200 depicted in FIG. 2, and/or the wireless device 300 depicted in FIG. 3 are described. If a beacon extension frame is carried in a PPDU other than a UHR PPDU, a non-UHR STA may be confused since it detects a broadcast frame that follows a non-DTIM beacon. In a first solution, the beacon extension frame is always transmitted in a UHR PPDU. In some embodiments, the beacon frame is transmitted immediately after the beacon extension frame. In a second solution, the beacon extension frame that follows a non-DTIM beacon is always transmitted in a UHR PPDU. The beacon extension frame that follows a DTIM beacon frame is always transmitted in a non-HT PPDU.

Some implementations of Critical Update Indication in beacon extension, for example, by the wireless communications system 100 depicted in FIG. 1, the multi-link (ML) communications system 200 depicted in FIG. 2, and/or the wireless device 300 depicted in FIG. 3 are described. In some embodiments, in order to same power of decoding a beacon extension frame, the Critical Update Flag and Nontransmitted BSSIDs Critical Update Flag are added before the other information in the beacon extension frame. In a first option, the Critical Update Flag and Nontransmitted BSSIDs Critical Update Flag in the beacon extension frame have the same meaning as the Critical Update Flag and Nontransmitted BSSIDs Critical Update Flag in the beacon frame. In another option, the Critical Update Flag and Nontransmitted BSSIDs Critical Update Flag in the beacon extension frame have the similar meaning as the Critical Update Flag and Nontransmitted BSSIDs Critical Update Flag in the beacon frame. The difference is that the Critical Update Flag and Nontransmitted BSSIDs Critical Update Flag in the beacon extension frame are applied the information in the beacon extension frame.

Some implementations of protected beacon extension frames, for example, by the wireless communications system 100 depicted in FIG. 1, the multi-link (ML) communications system 200 depicted in FIG. 2, and/or the wireless device 300 depicted in FIG. 3 are described. In some embodiments, although a beacon extension frame is a Broadcast Action frame, the encryption/decryption is done or performed through beacon integrity group temporal key (BIGTK), BIGTK packet number (BIPN). In some embodiments, the encryption/decryption of a beacon extension frame is done or performed through Integrity Group Temporal Key (IGTK), IGTK packet number (IPN).

Some implementations of Modulation Coding Scheme (MCS), number of spatial streams (Nss) for beacon extension frames, for example, by the wireless communications system 100 depicted in FIG. 1, the multi-link (ML) communications system 200 depicted in FIG. 2, and/or the wireless device 300 depicted in FIG. 3 are described. In Option 1, a beacon extension frame as a broadcast management frame can use the transmitter (Tx) parameters that are applied to Management frames except the beacon frame for UHR PPDU, e.g., UHR-MCS is the mandatory UHR MCS of one of the basic EHT MCS, Nss set, Nss is 1. For example, bandwidth (BW) is 20 MHz or the BW that is enabled by all associated UHR STAs. EHT Long Training Field (LTF) TYPE and Guard Interval (GI) TYPE are mandatory types. In Option 2, a beacon extension frame uses the beacon's rate, PPDU selection rules.

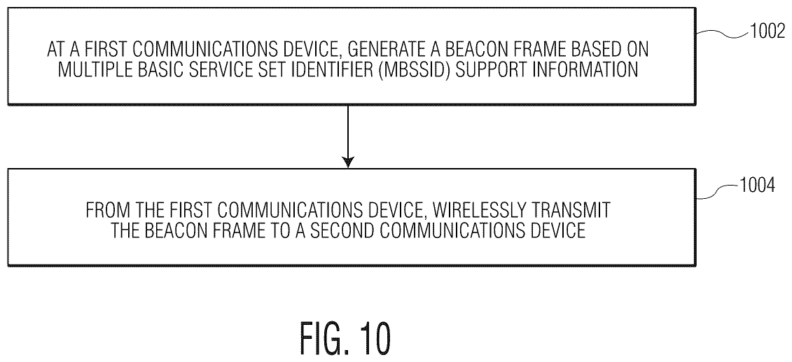

FIG. 10 is a process flow diagram of a method for wireless communications in accordance with an embodiment of the invention. At block 1002, at a first communications device, a beacon frame is generated based on Multiple Basic Service Set Identifier (MBSSID) support information. At block 1004, from the first communications device, the beacon frame is wirelessly transmitted to a second communications device. In some embodiments, the first communications device includes a wireless access point (AP) of a first wireless multi-link device (MLD), and the second communications device includes a wireless non-AP station (STA) of a second wireless MLD. In some embodiments, the beacon frame is generated based on the MBSSID support information and non-Ultra High Reliability (UHR) Station (STA) association allowance information. In some embodiments, the beacon frame that includes basic information is generated when MBSSID is not supported by the wireless AP and when non-UHR STA association is not allowed by the wireless AP, and the basic information includes an SSID element, a supported Rates and BSS Membership Selectors element, a traffic indication map (TIM) element, a security element, a transmit power control element, and critical update indication information and a BSS Parameters Change Count (BPCC). In some embodiments, the BPCC is increased and critical update information is distributed into beacon frames that include at least one delivery traffic indication map (DTIM) beacon frame, and a critical update flag field in the beacon frames is set to a specific value. In some embodiments, the beacon frame that includes BSS management information and UHR support indication information is generated when MBSSID is not supported by the wireless AP, and the BSS management information does not include UHR capability information and UHR BSS operating information. In some embodiments, the beacon frame that includes basic information is generated when MBSSID is supported by the wireless AP and when non-UHR STA association is not allowed by the wireless AP, and the basic information includes an SSID element, a supported Rates and BSS Membership Selectors element, a traffic indication map (TIM) element, a security element, a transmit power control element, and critical update indication information and a BPCC. In some embodiments, the BPCC is increased and critical update information is distributed into beacon frames that include at least one DTIM beacon frame, and a critical update flag field in the beacon frames is set to a specific value. In some embodiments, the beacon frame that includes BSS management information and UHR support indication information is generated when MBSSID is supported by the wireless AP, and the BSS management information does not include UHR capability information and UHR BSS operating information. In some embodiments, the beacon frame includes a BPCC of a wireless AP. In some embodiments, when a multi-link device (MLD) associated with the wireless AP has a new critical update, the BPCC is increased and the increased BPCC is carried in each link of the MLD. In some embodiments, a beacon extension frame is generated based on the MBSSID support information, and the beacon extension frame is transmitted to the second communications device after the beacon frame is transmitted. In some embodiments, the beacon extension frame includes multi-link traffic indication information that is not carried in the beacon frame. In some embodiments, the beacon extension frame is transmitted to the second communications device in a UHR physical layer protocol data unit (PPDU). In some embodiments, the beacon extension frame is transmitted to the second communications device in a UHR PPDU when the beacon frame includes a non-DTIM beacon frame or transmit the beacon extension frame to the second communications device in a non-High Throughout (HT) PPDU when the beacon frame includes a DTIM beacon frame. In some embodiments, the first communications device includes a wireless multi-link device (MLD), the second communications device includes a second wireless MLD, and the beacon frame is transmitted to the second wireless MLD through a wireless link between the wireless MLD and the second wireless MLD. In some embodiments, the first communications device and/or the second communications device are compatible with an Institute of Electrical and Electronics Engineers (IEEE) 802.11 protocol. some embodiments, the first communications device is a component of a multi-link device (MLD). The first communications device and/or the second communications device may be the same as or similar to an embodiment of the AP 106 depicted in FIG. 1, the APs 206-1, 206-2 depicted in FIG. 2, the wireless device 300 depicted in FIG. 3, the AP 506 depicted in FIG. 5, and/or the APs 806-1, 806-2, 806-3, 806-4 depicted in FIG. 8.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner. It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A communications device comprising:
a controller configured to generate a beacon frame based on Multiple Basic Service Set Identifier (MBSSID) support information; and
a wireless transceiver configured to wirelessly transmit the beacon frame to a second communications device.

2. The communications device of claim 1, wherein the beacon frame does not carry at least some access point (AP)'s capability and BSS operation information.

3. The communications device of claim 1, wherein the communications device comprises a wireless access point (AP) of a first wireless multi-link device (MLD), and wherein the second communications device comprises a wireless non-AP station (STA) of a second wireless MLD.

4. The communications device of claim 3, wherein the controller is further configured to generate the beacon frame based on the MBSSID support information and non-Ultra High Reliability (UHR) Station (STA) association allowance information.

5. The communications device of claim 4, wherein the controller is further configured to generate the beacon frame that comprises capability and BSS operation information other than UHR capability information and at least one UHR BSS operating parameter, and an indication whether the communications device supports UHR.

6. The communications device of claim 4, wherein the controller is further configured to generate an indication whether a critical change of a plurality of UHR BSS operating parameters occurs and a BSS change count related to the critical change of the UHR BSS operating parameters.

7. The communications device of claim 6, wherein the controller is further configured to carry the critical change in a plurality of beacon frames that comprise at least one delivery traffic indication map (DTIM) beacon frame.

8. The communications device of claim 4, wherein the controller is further configured to generate the beacon frame that comprises basic information when MBSSID is not supported by the wireless AP and when non-UHR STA association is not allowed by the wireless AP, and wherein the basic information comprises:
an SSID element;
a supported Rates and BSS Membership Selectors element;
a traffic indication map (TIM) element;
a security element;
a transmit power control element; and
critical update indication information and a BSS Parameters Change Count (BPCC).

9. The communications device of claim 8, wherein the controller is further configured to increase the BPCC and to distribute critical update information into a plurality of beacon frames that comprise at least one delivery traffic indication map (DTIM) beacon frame, and wherein a critical update flag field in the beacon frames is set to a specific value.

10. The communications device of claim 9, wherein the controller is further configured to generate an indication whether a critical change of a plurality of UHR BSS operating parameters occurs and a BSS change count related to the critical change of UHR BSS operating parameters.

11. The communications device of claim 4, wherein the controller is further configured to generate the beacon frame that comprises BSS management information without UHR information and at least one BSS operating parameter, and UHR support indication information when MBSSID is not supported by the wireless AP, and wherein the BSS management information does not comprise UHR capability information and UHR BSS operating information.

12. The communications device of claim 4, wherein the controller is further configured to generate the beacon frame that comprises basic information when MBSSID is supported by a wireless transmitted BSSID AP of a multiple BSSID set and when non-UHR STA association is not allowed for any AP within the multiple BSSID set, and wherein the basic information comprises:
an SSID element;
a supported Rates and BSS Membership Selectors element;
a traffic indication map (TIM) element;
a security element;
a transmit power control element; and
critical update indication information and a BSS Parameters Change Count (BPCC).

13. The communications device of claim 12, wherein the controller is further configured to increase the BPCC and to distribute critical update information into a plurality of beacon frames that comprise at least one delivery traffic indication map (DTIM) beacon frame, and wherein a critical update flag field in the beacon frames is set to a specific value.

14. The communications device of claim 4, wherein the controller is further configured to generate the beacon frame that comprises BSS management information and UHR support indication information when MBSSID is supported by a wireless transmitted BSSID AP of a multiple BSSID set and at least one AP of the multiple BSSID set allows non-UHR STA's association, and wherein the BSS management information does not comprise UHR capability information and UHR BSS operating information.

15. The communications device of claim 14, wherein the controller is further configured to generate an indication whether a critical change of a plurality of UHR BSS operating parameters occurs and a BSS change count related to the critical change of the UHR BSS operating parameters, and wherein a plurality of beacon frames that comprise at least one delivery traffic indication map (DTIM) beacon frame.

16. The communications device of claim 1, wherein the beacon frame comprises a BSS Parameters Change Count (BPCC) of a wireless access point (AP), and wherein when a multi-link device (MLD) associated with the wireless AP has a new critical update, the BPCC is increased and an increased BPCC is carried in each link of the MLD.

17. The communications device of claim 1, wherein the controller is further configured to generate a beacon extension frame based on the MBSSID support information, wherein the beacon extension frame comprises multi-link traffic indication information that is not carried in the beacon frame, and wherein the wireless transceiver is further configured to transmit the beacon extension frame to the second communications device after the beacon frame is transmitted.

18. The communications device of claim 17, wherein the wireless transceiver is further configured to transmit the beacon extension frame to the second communications device in an Ultra High Reliability (UHR) physical layer protocol data unit (PPDU) when the beacon frame comprises a non-delivery traffic indication map (DTIM) beacon frame or transmit the beacon extension frame to the second communications device in a non-High Throughout (HT) PPDU when the beacon frame comprises a DTIM beacon frame.

19. A wireless access point (AP) compatible with an Institute of Electrical and Electronics Engineers (IEEE) 802.11 protocol, the wireless AP comprising:
a controller configured to generate a beacon frame based on Multiple Basic Service Set Identifier (MBSSID) support information and non-Ultra High Reliability (UHR) Station (STA) association allowance information; and
a wireless transceiver configured to transmit the beacon frame to a second communications device.

20. A method for wireless communications, the method comprising:
at a first communications device, generating a beacon frame based on Multiple Basic Service Set Identifier (MBSSID) support information; and
from the first communications device, wirelessly transmitting the beacon frame to a second communications device.
